(19) United States
(12) Patent Application Publication
(10) Pub. No.: US 2025/0285424 A1
(43) Pub. Date: Sep. 11, 2025

(54) SYSTEM AND METHOD FOR MULTI-MODAL CONTRAST IN FEW-SHOT CLASSIFICATION

(71) Applicant: The Hong Kong University of Science and Technology, Hong Kong (CN)

(72) Inventor: Song GUO, Hong Kong (CN)

(21) Appl. No.: 19/069,146

(22) Filed: Mar. 3, 2025

Related U.S. Application Data
(60) Provisional application No. 63/561,336, filed on Mar. 5, 2024.

(51) Int. Cl. G06V 10/80; G06F 40/284; G06V 10/764

(52) U.S. Cl. CPC G06V 10/811; G06F 40/284; G06V 10/764

(57) ABSTRACT

An LMMs-boosted LMC framework system includes a user interface, a multi-modal feature generation module, a multi-modal feature contrast module, and a prediction logic module. The user interface operates in support image mode to process support set images for training, transforming them into text and visual features within a multi-modal support feature pool. In test image mode, the user interface transmits test images to the contrast module, which compares their features with the support pool using visual and textual modalities. The prediction logic module integrates these comparisons to generate a classification index with the most likely classification and confidence score.

### TECHNICAL FIELD

The present invention generally relates to the field of machine learning and artificial intelligence, particularly to systems and methods for few-shot classification using large multi-modal contrast framework.

### BACKGROUND

Recently, Vision-Language Models (VLMs) have demonstrated favorable transfer capability on tasks such as classification, segmentation, and image retrieval. By being trained on 400M image-text pairs with contrastive loss, Contrastive Language-Image Pretraining (CLIP) aligns features of different data modalities (e.g., visual and text) in a shared representation space and exhibits strong zero-shot image classification ability. Many approaches have been developed to adapt CLIP's generalization ability to various downstream few-shot classification tasks using a limited amount of labeled samples. Apart from fine-tuning methods like Linear-probe, CoOp, and CLIP-Adapter, which require intensive computation and are prone to over-fitting, feature caching is offered as an efficient scheme.

In few-shot settings, a small number of domain-specific labeled images and all class labels can be provided as a support set. Due to the lack of effective prior knowledge from unseen classes, during inference, Tip-Adapter(-F) first contrasts the visual feature of a test image with the CLIP classifier to retain CLIP's zero-shot capability. Then, similarity scores between the test image feature and cached support image features are calculated as weights to resemble one-hot labels, which is referred to as adaptation. These two-stage logits are blended residually to produce the final prediction. Subsequent research, including Tip-X, CaFo, and DAC, generally inherits this structure, namely zero-shot CLIP plus visual cache contrast.

However, three drawbacks remain unaddressed in existing works. First, images are processed only by a visual encoder in a single-modality manner, leaving features of other modalities, such as textual content, hidden and unused. Second, current methods rely solely on a distance metric by calculating cosine similarity in the visual embedding space, which is shown to be suboptimal in this context. Third, although the CLIP classifier weights can be interpreted as cross-modal contrast learning, the class names in text prompts are domain-agnostic, as is the KL-divergence component in Tip-X. The lack of domain-specific information ultimately limits the generalization performance on target tasks.

In real-world scenarios, multi-modal signals and representations (e.g., seeing, reading, listening) are typically perceived when new concepts are learned. For example, linguistic descriptions are shown to be effective in recognizing unseen visual concepts with limited examples, especially through the inclusion of key terms. Therefore, there is a need for methods that extend the distance metric to multi-modal and cross-modal settings, addressing data-deficient few-shot classification tasks.

### SUMMARY OF INVENTION

It is an objective of the present invention to provide systems and methods to address the aforementioned shortcomings and unmet needs in the state of the art.

In the present invention, a Large Multi-modal Models-boosted (LMMs-boosted) Multi-modal Contrast (LMC) framework for few-shot classification is proposed. LMMs are introduced to generate sample images' discriminative descriptions for the text encoder to leverage the hidden correlations of concepts in textual embedding space and embrace domain-specific knowledge. By merging textual and visual embeddings, a multi-modal support feature pool is further built for representation contrast during inference. The optimal distance metric in both multi-modal and cross-modal regimes is further explored through modal masks. LMC framework (i.e., LMC solution) is proposed with mainly consisting of

two novel stages: (i) multi-modal feature generation; and (ii) multi-modal feature contrast during inference. LMMs are introduced as a bridge to convert images into linguistic descriptions, making it possible to leverage textual embeddings of sample images through the text encoder.

Specifically, for a given downstream few-shot task, during the first stage, an LMM and the CLIP text encoder are coupled in series, converting support images into texts and then into textual features, which contain salient semantic and concept correlations from the textual embedding space. Meanwhile, visual features are extracted by the CLIP visual encoder. By this stage, the support images' features in both textual and visual embedding spaces are generated, and the multi-modal support feature pool is formed through direct integration in the next stage.

During inference, test images undergo the same process as support images to obtain textual and visual embeddings, respectively. To determine the multi-modal or cross-modal distance metric, two modal masks are applied to the constructed feature pool in dual embedding spaces, generating two predictions. Zero-shot CLIP is incorporated into the final output to maintain distribution generalization. By extracting textual features with LMMs' pre-learned knowledge, domain information in data-deficient scenarios is fully utilized, and the distance metric is extended from single-modality to multi-modal and cross-modal regimes.

In accordance with an aspect of the present invention, a LMMs-boosted LMC framework system is provided for executing the LMC solution. The LMMs-boosted LMC framework system includes a user interface, a multi-modal feature generation module, a multi-modal feature contrast module, and a prediction logic module. The user interface is configured to receive input images and operating in two distinct modes, including a support image mode and a test image mode. The user interface in the support image mode receives support set images and send them to the multi-modal feature generation module. The support set images are utilized for system training, and the multi-modal feature generation module is configured to transform the support set images into text features and visual features and deliver them into a multi-modal support feature pool to support an inference stage. The user interface in the test image mode receives at least one test image and sends them to the multi-modal feature contrast module. The multi-modal feature contrast module is configured to compare test image features of the test image with the support set features within the multi-modal support feature pool and to calculate similarities between the test image features and the support set features across visual and textual modalities. The prediction logic module is configured to integrate predictions from multiple sources generated by the multi-modal feature contrast module to produce a classification index for the test image with the most likely classification and its associated confidence score.

In accordance with an aspect of the present invention, a method for using the LMMs-boosted LMC framework system is provided to execute a training stage using a support image set. The method includes steps as follows: receiving, by the LMMs-boosted LMC framework system, a support image set as input during a training stage; transmitting, by the user interface in the support image mode, support images of the support image set to the multi-modal feature generation module for processing; transforming, by a large multi-modal module of the multi-modal feature generation module, the support images into multiple textual descriptions to reduce semantic variability; passing the textual descriptions to a text encoder module of the multi-modal feature generation module, which computes the corresponding text embedding features; processing, by a visual encoder module of the multi-modal feature generation module, the support images to extract visual embedding features, thereby converting raw image data into high-dimensional vectors capturing both semantic and structural information; and combining, by the multi-modal feature generation module, the text and visual embedding features to construct the multi-modal support feature pool for subsequent contrast operations during the inference stage.

In accordance with an aspect of the present invention, a method for using the LMMs-boosted LMC framework system is provided to execute an inference stage with respect to at least one test image for classification. The method includes steps as follows: receiving, by the LMMs-boosted LMC framework system, at least one test image as input during the inference stage; transmitting, by the user interface in the test image mode, the test image to the multi-modal feature contrast module; processing, by a test feature extraction module of the multi-modal feature contrast module, the test image using an internal visual encoder model to extract visual features and an internal text encoder model to derive text features from the textual descriptions of the test image, obtaining test image features; comparing the test image features with the multi-modal support feature pool; performing a contrast process by a mask function module of the multi-modal feature contrast module to determine whether to use visual features, textual features, or both for comparison based on predefined mask functions; performing similarity calculations by an exponential function module of the multi-modal feature contrast module using affinity metrics, with adjustable parameters to control sharpness of predictions; transmitting a result of comparison executed by the exponential function module to the prediction logic module; generating, by a zero-shot prediction module of the prediction logic module, an initial prediction based on the visual features of the test image; and integrating, by a logic fusion module of the prediction logic module, the initial prediction with the result from the multi-modal feature contrast module to produce a refined prediction, serving as the classification index.

By this configuration, the LMC solution leverages the unused features of sample images in the text embedding space. This solution introduces LMMs into few-shot classification tasks to utilize the hidden correlations of concepts in data-deficient scenarios. A multi-modal support feature pool is built, and the existing single-modal distance metric is extended to multi-modal and cross-modal regimes through modal masks. Comprehensive experiments are conducted on 11 few-shot datasets, where LMC outperforms all baselines in both training-free and training-required regimes, achieving remarkable robustness to distribution shifts (surpassing baselines by up to 11.70%). As such, state-of-the-art few-shot classification results are achieved by LMC on 11 benchmark datasets, demonstrating exceptional performance on OOD robustness tasks.

### BRIEF DESCRIPTION OF DRAWINGS

Embodiments of the invention are described in more details hereinafter with reference to the drawings, in which:

FIG. 1 illustrates a support set consisting of a golden dog and a white cat.

FIG. 2A and FIG. 2B show inter-class similarity scores in textual space and visual space respectively;

FIG. 3 shows a schematic comparison between part (a) single visual-modal contrast and part (b) multi-modal contrast;

FIGS. 4A and 4B show overview of the framework of the proposed LMC according to some embodiments of the present invention;

FIG. 5 shows Table 1 for Quantitative performance comparison;

FIGS. 6A and 6B show comparison of accuracy obtained by different few-shot classification models on 11 datasets;

FIG. 7 shows Table 2 for Distribution shift comparison;

FIG. 8 demonstrates examples from Caltech101, including part (a) Lamp vs Umbrella and part (b) Chair vs Menorah;

FIG. 9 shows Table 3 for ablation study of modal mask for LMC-T.

FIG. 10 shows Table 4 for an ablation of LMMs;

FIG. 11 shows Table 5 for an ablation of different visual encoders; and

FIG. 12 depicts an overview of the block configuration of a LMMs-boosted LMC framework system according to one embodiment of the present invention.

### DETAILED DESCRIPTION OF THE INVENTION

In the following description, methods for few-shot classification using large multi-modal contrast framework and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

An introduction to Large Multi-modal Models (LMMs) is provided. LMMs framework can improve few-shot tasks' accuracy. In image captioning tasks, text descriptions are generated by multi-modal models. These descriptions are argued to benefit few-shot classification tasks mainly from three perspectives.

First, ambiguity can be reduced, and the descriptions can act as an interference filter by highlighting the salient semantics of input images. In contrast, the visual encoder maps all features into the visual embedding space, including background and misleading details. Second, for easy samples, LMMs can perform coarse-grained classification since class names may directly appear in descriptions. Third, for hard samples, the hidden correlations of textual concepts can function as multi-label guidance, directing classification towards the ground truth.

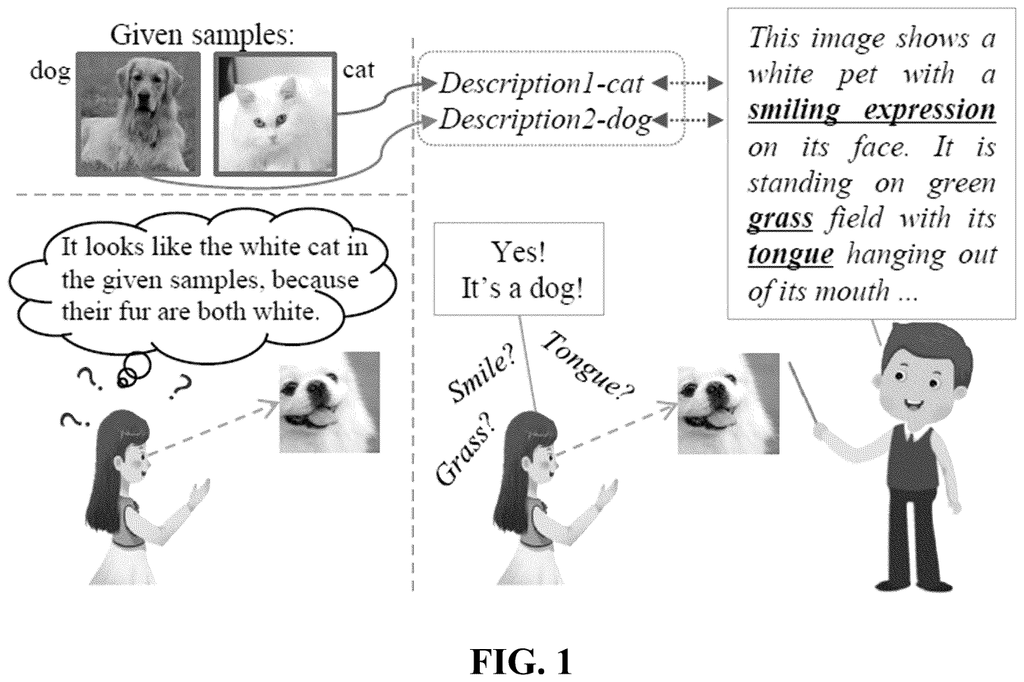

For example, FIG. 1 illustrates a support set consisting of a golden dog and a white cat. Existing methods commonly apply a single visual distance metric when another similar golden dog is provided as the test input. However, in the case of a white dog that shares high visual similarity with the negative support class, the key concepts (“dog,” “tongue,” “bark,” “grass,” etc.) in descriptions often appear together with higher probability, offering guidance as “hidden” information. Multi-modal information facilitates efficient learning of new concepts. When limited examples of new concepts are available, visual information alone may be insufficient, and additional textual descriptions can assist in differentiation.

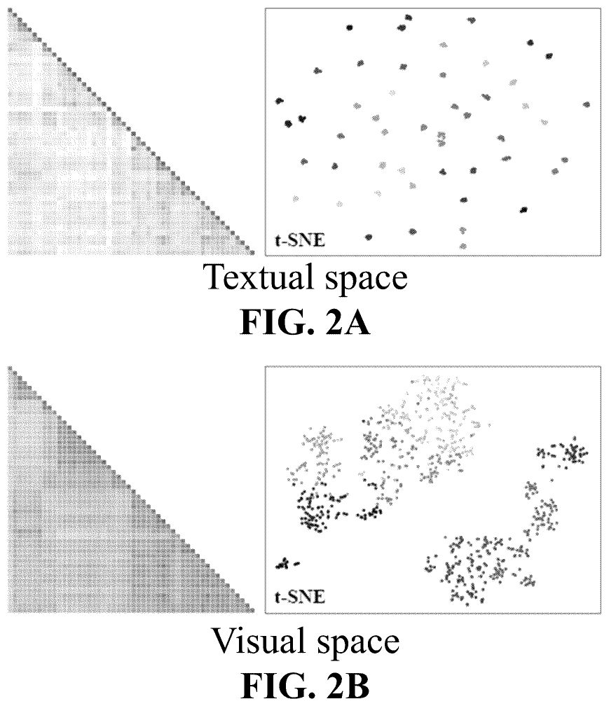

FIG. 2A and FIG. 2B show inter-class similarity scores in textual space and visual space respectively. FIG. 2A and FIG. 2B demonstrates that, compared to the visual embedding space, the average intra-class similarity scores are significantly higher than inter-class similarity scores in the textual space, enhancing its discriminative capability. In the illustrations, Intra-class and inter-class cosine similarities and 2D t-SNE embedding visualizations of different modalities are analyzed. Fifty classes are randomly selected from the ImageNet dataset, and features are extracted from image pixels and descriptions provided by LMM using visual and text encoders, respectively. The visualization of average similarities across intra-class (diagonal) and inter-class categories indicates that features in the textual space are more discriminative, as confirmed by the t-SNE visualizations.

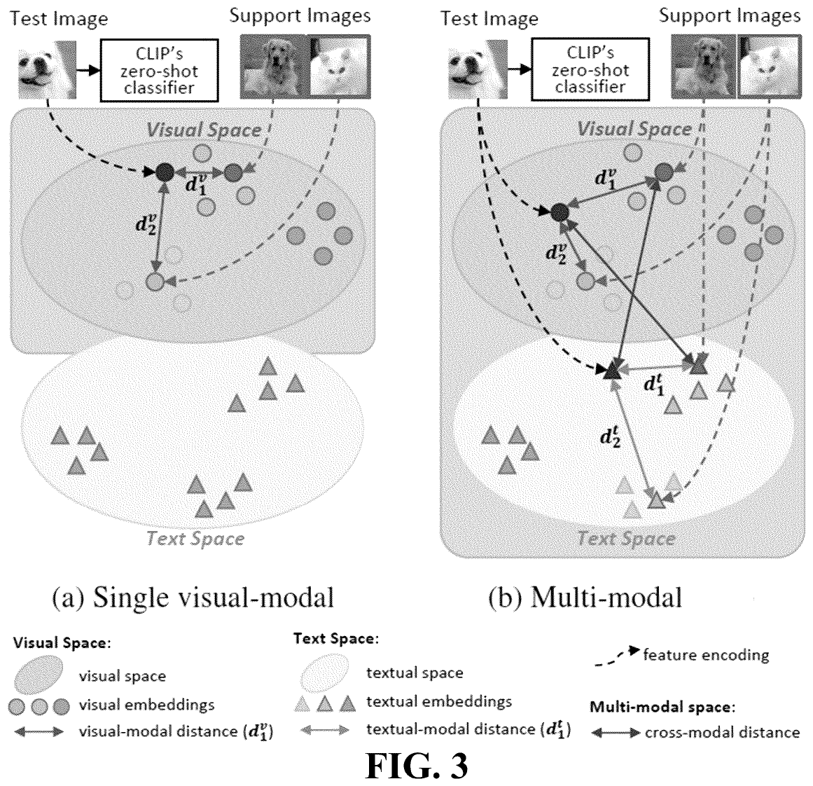

In the real world, humans typically perceive multi-modal signals and representations (e.g., seeing, reading, listening) when learning new concepts. Extending the distance metric to multi-modal and cross-modal settings is therefore a promising solution for data-deficient few-shot classification tasks. FIG. 3 shows a schematic comparison between part (a) single visual-modal contrast and part (b) multi-modal contrast. Part (a) corresponds to existing methods (single visual-modal contrast) that map support and test images into the visual embedding space and perform single-modal contrast. In contrast, part (b) illustrates multi-modal contrast, which explores optimal distance metrics across modalities.

The related work on models or classification is provided, including introduction to pre-training of vision-language models, few-shot classification, and large multi-modal models (LMMs).

Pre-training of Vision-Language Models: contrast learning has been well studied for various visual representation learning, leading to the proliferation of large-scale vision-language pre-trained models. By training on web-scale image-text pairs, CLIP achieves remarkable performance on visual tasks by aligning features of different modalities in a joint embedding space. These aligned representations contribute to impressive zero-shot transfer abilities across various downstream tasks such as object detection, semantic segmentation, generative models, image captioning, and retrieval, among others.

Few-shot Classification: few-shot classification methods can be divided into three categories: data augmentation, optimization-based, and metric learning. Data augmentation methods address the data scarcity problem by expanding the labeled sample size using augmentation strategies. Optimization-based approaches design meta-learning techniques to enable fast parameter updates with continuous episodes. Metric learning algorithms apply designed distance metrics to specific feature spaces and conduct classification by quantifying the distance between test and support samples.

The emergence of vision-language pre-training models like CLIP has introduced new ideas. To further adapt CLIP to few-shot classification tasks, fine-tuning on labeled samples from the target domain is an effective yet computationally expensive approach. A more flexible and efficient strategy involves adaptive methods, either by optimizing the prompts of the text encoder or updating additive lightweight adapter layers, both of which keep the pre-trained weights frozen. From the perspective of distance metrics, cache models have gained popularity since Tip-Adapter(-F), which constructs key-value caches with samples' visual embeddings and utilizes cosine similarity as the distance metric. Subsequently, Tip-X introduced KL-divergence for metric optimization, and DAC aimed for cache alignment through an additional adapter layer before the cache model. CaFo adopts dual visual caches but falls under the data augmentation scope as it expands few-shot samples using generative models.

Large Multi-modal Models (LMMs): Large Multi-modal Models aim to serve as experts in visual understanding and generation tasks, primarily functioning as a conversion layer between image and text. BLIP pre-trains a multi-modal model using large-scale noisy image-text pairs with a caption generator and noise filter. As large language models (LLMs) rapidly evolve, BLIP2 and InstructBLIP train Q-formers to connect vision encoders with LLMs, while LLaVA and MiniGPT4 focus on lightweight linear projectors through in-context instruction tuning.

In the present invention, LMMs are introduced into the solution, utilizing their pre-learned knowledge to extract textual features of few-shot examples with visual understanding capabilities.

The following explains the principles and mechanisms of the solution.

### Problem Definition:

Considering a N-way K-shot few-shot classification task in target domain (K<<N), we have K annotated images for each of the N categories, denoted as the support set: S={(xᵢ, yᵢ)}ᵢ₌₁^{NK}, where (xᵢ, yᵢ) is paired support image and label. Based on this prior few-shot knowledge, the goal is to obtain the class label of test images (also called query images) from unlabeled test set: T={(qⱼ)}ⱼ₌₁^{Q}, where Q is the size of test set consisting of N classes.

### Contrastive Vision Language Model.

CLIP aligns visual and textual feature in joint embedding space by learning on large image-text dataset. During inference, text encoder encodes the prompted class labels into D-dimensional classifier weight matrix W_{Clip}=∈ [symbol] ^{N×D}. For test image Iₜₑₛₜ∈T, CLIP's visual encoder is applied to generate visual feature:

$${f}_{test} = V i s u a l E n c o d er ( {I}_{test} ) ∈ {ℝ}^{1 \times D} \qquad ( 1 )$$

CLIP calculates prediction logits by multiplying test visual feature and classifier matrix via dot product:

$${logits}_{z ero - shot} = {f}_{test} {W}_{C l i p}^{T} ∈ {ℝ}^{N \times 1} \qquad ( 2 )$$

Since no sample information is used as prior knowledge and class names in prompt template are task-agnostic, classifier matrix W_{Clip} denotes the ability of zero-shot classification.

### Cache-based Models:

CLIP can be adapted to few-shot classification tasks by constructing cache model. Given labeled support set S, Tip-Adapter encodes S with CLIP's visual encoder to reserve few-shot knowledge:

$${f}_{i} = V i s u a l E n c o d e r ( {x}_{i} ) ∈ {ℝ}^{1 \times D} , i ∈ [ 1 , N \times K ] \qquad ( 3 )$$

These visual embeddings are concatenated as keys of cache model Fᵥᵢₛᵤₐₗ∈ [symbol] ^{NK×D} and the corresponding cache value are one-hot vectors L∈ [symbol] ^{NK×D} converted from class labels. During inference, the similarities between fₜₑₛₜ and Fᵥᵢₛᵤₐₗ are computed as affinity matrix A for linear combination of cached values:

$$A = φ ( {f}_{test} {F}_{v i s u a l}^{T} ) ∈ {ℝ}^{N \times 1} \qquad ( 4 )$$

where φ(x)exp (−β(1−x)) is an exponential function and β is a hyper-parameter controlling the sharpness of prediction AL∈ [symbol] ^{1×N}. To retain the few-shot ability of CLIP, two prediction logits are blended via residual connection:

$${logits}_{z e r o - shot} = {f}_{test} {W}_{C l i p}^{T} + α AL ∈ {ℝ}^{1 \times N} \qquad ( 5 )$$

where α trades off the contribution of two predictions.

### LMC Solution:

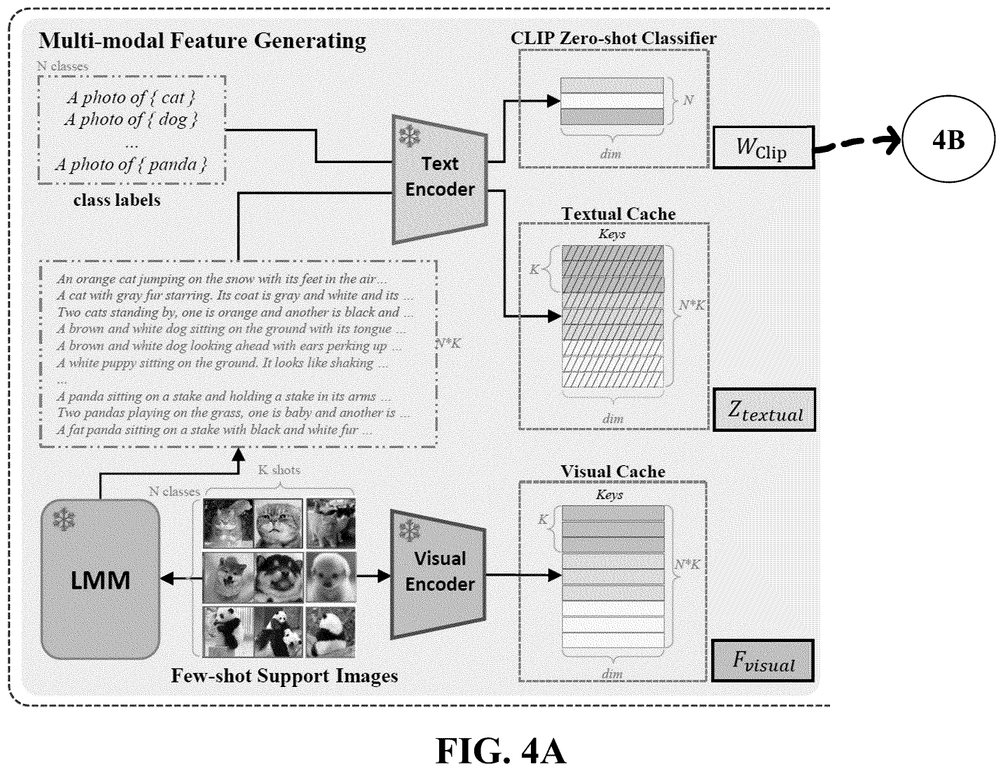

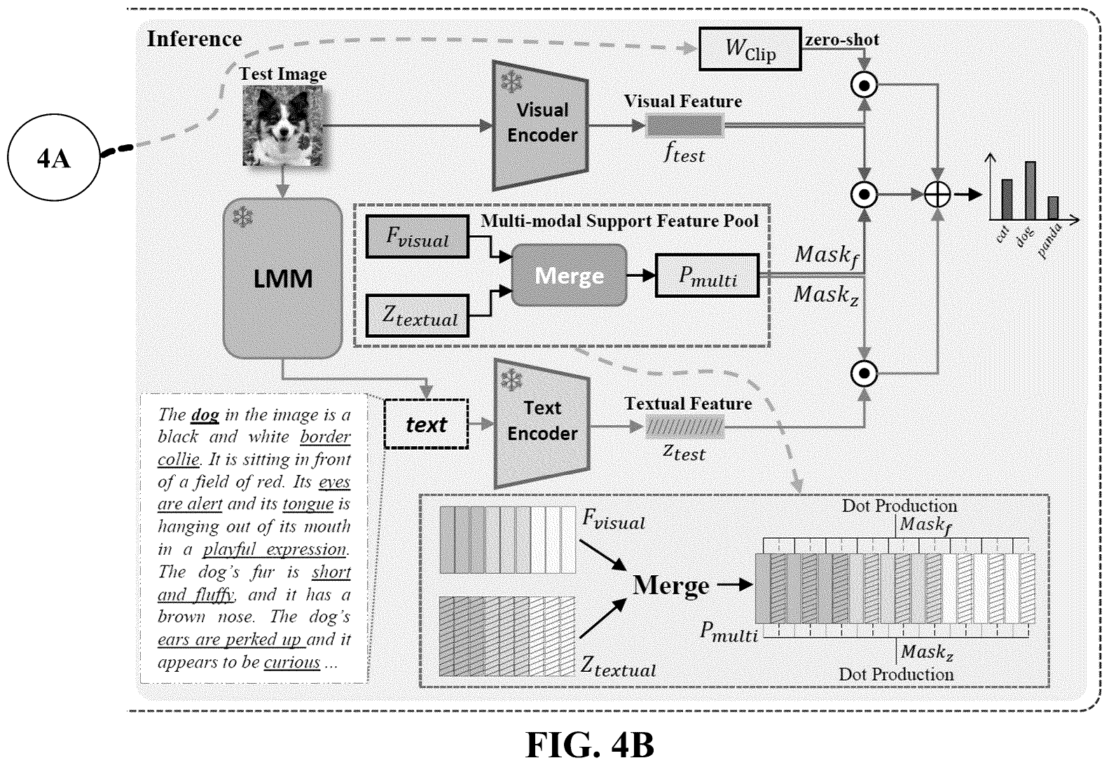

FIGS. 4A and 4B show overview of the framework of the proposed LMC according to some embodiments of the present invention. The LMC consists of first and second stages. The first stage is multi-modal feature generating, as shown in FIG. 4A, where LMMs are introduced to convert support images into descriptions and then into textual feature by text encoder. The second stage is multi-modal contrast during inference, as shown in FIG. 4B. Briefly, two modal masks are adopted to determine multi-modal or cross-modal contrast for test textual and visual features against the constructed support feature pool. Three logits are blended to obtain joint similarities between test images and the support set. LMM is employed as an interference filter and coarse-grained classifier to extract salient semantics and leverage the hidden correlations of concepts for multi-label guidance.

### The First Stage: Multi-Modal Feature Generating.

Input images only contains visual information in pixel value. Other than caching visual features of support images as Tip-Adapter, LMM is introduced as a bridge to map images into text descriptions and directly obtain textual features by combining a text encoder in series. Specifically, NK support images {xᵢ}ᵢ₌₁^{NK} are firstly transferred into text descriptions by LMM. Each image is captioned M times to eliminate description variance, denoted as Dᵢ:

$${D}_{i} = LM M ( {x}_{i} ) , i ∈ [ 1 , NK ] \qquad ( 6 )$$

where Dᵢ consists of M sentences and we adopt BLIP and miniGPT-4 as LMM for ablation. Next, the mean textual feature is computed with frozen CLIP's text encoder since feature ensemble can improve accuracy on recognition tasks:

$${Z}_{i} = \frac{1}{\vert {D}_{i} \vert} {{\sum }_{j = 1}^{M} [ T e x t E n c o d e r ( {D}_{i} ) ]}_{j} , i ∈ [ i , NK ] \qquad ( 7 )$$

$${Z}_{textual} = Concat ( [ {Z}_{1} , {Z}_{2} , … , {Z}_{N K} ] ) ∈ {ℝ}^{N K \times D} \qquad ( 8 )$$

where Zᵢ is the mean feature of i-th support image in textual embedding space and textual cache Zₜₑₓₜᵤₐₗ shares same dimension with visual cache Fᵥᵢₛᵤₐₗ. Now, features of both textual and visual modality are available for further inference.

### The Second Stage: Multi-Modal Feature Contrast.

During inference, the feature of test image Iₜₑₛₜ is extracted in both visual (fₜₑₛₜ) and textual (zₜₑₛₜ∈ [symbol] ^{1×D}) embedding space. Rather than directly computing similarities between fₜₑₛₜ and visual cache Fᵥᵢₛᵤₐₗ, it is proposed to extend single-modal contrast to multi-modal and cross-modal. More specifically, a multi-modal support feature cache pool Pₘᵤₗₜᵢ is formulated by directly merging visual and textual cache, as shown in FIG. 4B. For test features in both visual and textual embedding space, two mask functions are adopted to conduct support cache modality selection and then two distance metrics are constructed as prediction logits:

$${logits}_{v i s u a l} = α \cdot {φ}_{f} ( {f}_{test} {Mask}_{f} ( {P}_{multi} ) ) \cdot L \qquad ( 9 )$$

$${logits}_{textual} = γ \cdot {φ}_{z} ( {z}_{test} {Mask}_{z} ( {P}_{multi} ) ) \cdot L \qquad ( 10 )$$

where φ_{f} and φ_{z} are exponential functions in form of φ but with different sharpness hyper-parameters (β in φ_{f}, and δ in φ_{z}), L denotes one-hot labels, a and y are two balance scalar. Mask_{f} and Mask_{z}∈ [symbol] ^{2NK} are mask functions:

$$Mask = ψ ( {m}_{f} , {m}_{z} ) = [ {m}_{f} , {m}_{z} , … , {m}_{f} , {m}_{z} ] \qquad ( 11 )$$

where ψ(⋅) denotes mask function, m_{f}, m_{z}∈{0,1} determine whether to calculate similarity between test feature and support visual feature or textual feature in cache pool respectively. For example, Mask_{z}=ψ(1,0) means cross modal contrast between ztest and support visual cache. Specially, {Mask_{f}=ψ(1,0), Mask_{z}=ψ(0,0)} makes Tip-Adapter a special form of our proposed LMC. Considering inference speed, normally, value of either m_{f} or m_{z} is set as 1. Empirically, {Mask_{f}=ψ(1,0), Mask_{z}=ψ(1,0)} is better for fine-grained datasets and {Mask_{f}=ψ(1,0), Mask_{z}=ψ(0,1)} for normal coarse-grained datasets. Finally, the proposed predicted logits is blended as:

$$logits = {f}_{test} {W}_{C l i p}^{T} + {logits}_{v i s u a l} + {logits}_{textual} \qquad ( 12 )$$

By updating parameters of Pₘᵤₗₜᵢ on support set, the proposed LMC solution can be extended from training-free to fine-tuned version of LMC-T.

Experiments are conducted to demonstrate the feasibility and performance of the solution.

### Experiment-Settings:

Datasets: experiments are conducted on 11 public datasets for comprehensive evaluation, including: ImageNet, StandfordCars, UCF101, Caltech101, Flowers102, SUN397, DTD, EuroSAT, FGVCAircraft, OxfordPets, and Food101.

Implementation Details: the few-shot protocol is followed, and results are reported using 1-, 2-, 4-, 8-, and 16-shots per class, which are randomly sampled from the training set. Hyper-parameter α, β, γ, δ are tuned by grid search on official validation sets. The training-free LMC is extended to fine-tuned LMC-T by updating the parameters of the multi-modal support feature pool while keeping the cache keys LLL frozen. Finetuning is conducted on a single GPU with a batch size of 256 for 20 epochs, utilizing the AdamW optimizer with an initial learning rate of 0.0001 and a cosine scheduler. All methods employ pre-trained CLIP with a frozen ResNet-50 visual encoder. BLIP is utilized to generate M=20 short descriptions, and MiniGPT4 is utilized for both short and long descriptions. LMC is compared with current cache-based few-shot methods, including Tip-Adapter(-F), Tip-X, and DAC-V. CaFo and DAC-VT are excluded from the comparison due to CaFo leveraging generative models for data expansion and DAC-VT setting the CLIP classifier as learnable.

### Experiment-Performance:

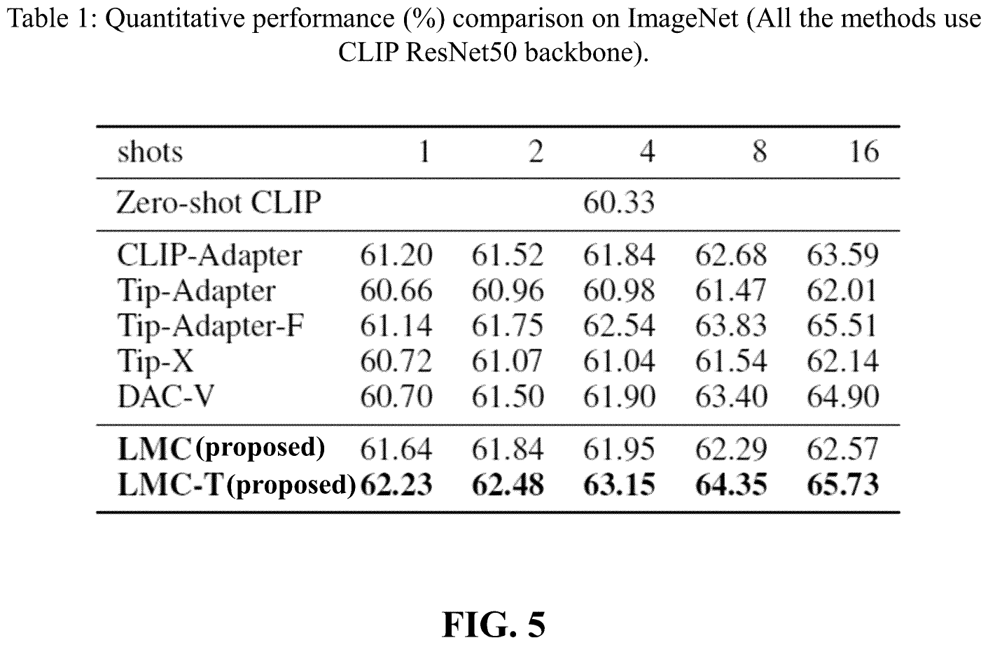

Results on ImageNet: training-free LMC and training-required LMC-T are compared with baselines on ImageNet. As reported in Table 1 of FIG. 5, LMC-T surpasses all methods in various few-shot settings by a significant margin. Compared with Tip-X, LMC demonstrates a larger improvement over Tip-Adapter, achieving the best performance in the training-free regime. Notably, without any training, LMC outperforms fine-tuned Tip-Adapter-F and DAC-V in low-shot scenarios, achieving 61.64% and 61.84% in 1-shot and 2-shot settings, respectively.

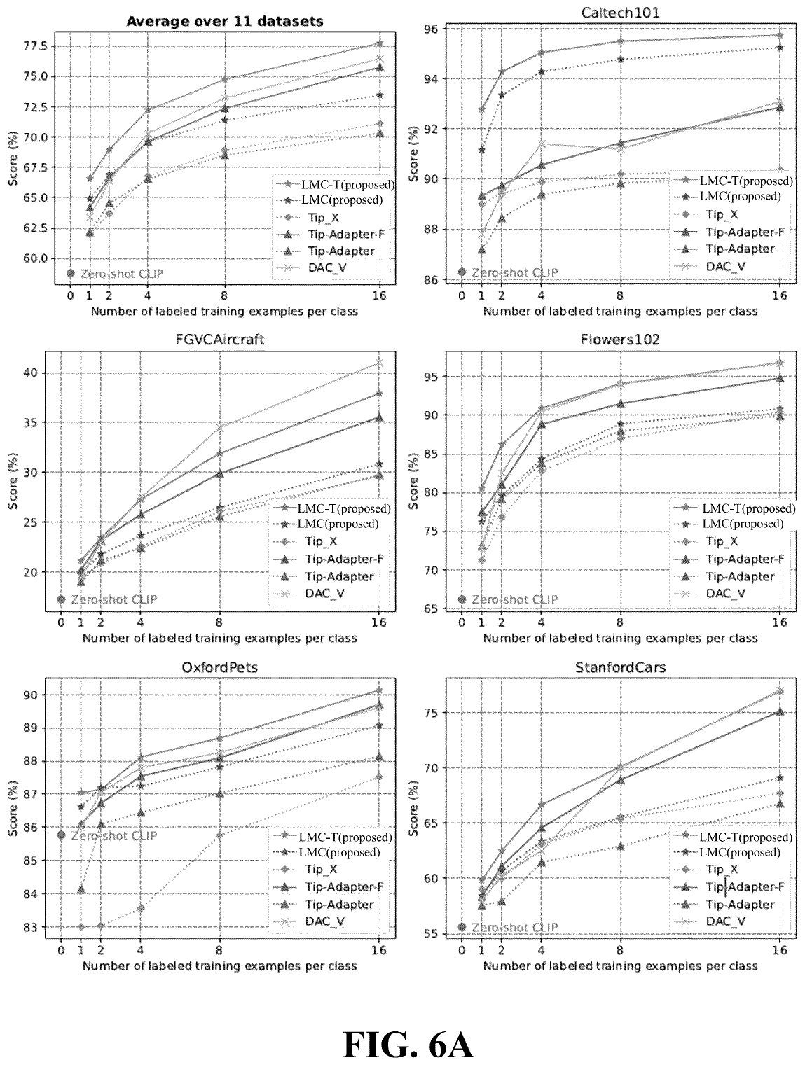

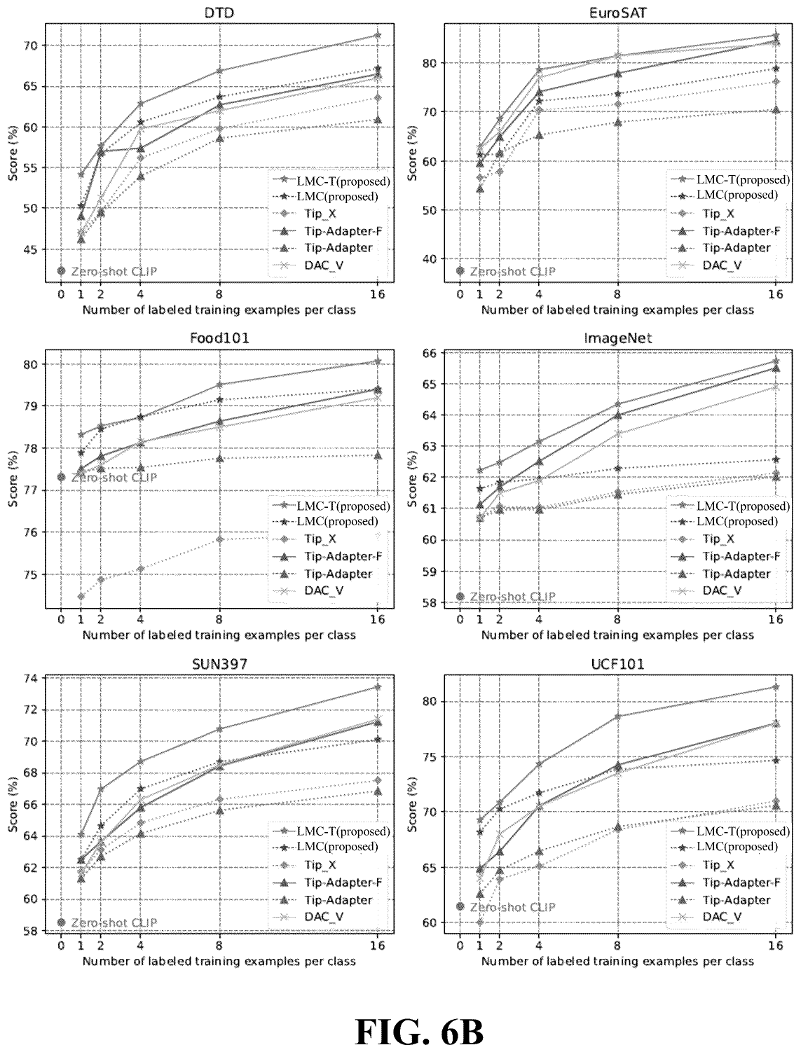

Performance on Other Datasets: FIGS. 6A and 6B show comparison of accuracy (%) obtained by different few-shot classification models on 11 datasets.

The x-axis represents the shots of training examples per class from the target domain. Dashed lines are training-free methods while solid lines denote models that require fine-tuning on support set. In the illustration, the method is assessed on 11 datasets from different semantic domains. LMC consistently achieves the highest accuracy among all training-free baselines and performs comparably to or better than fine-tuned baselines in 1-, 2-, and 4-shot settings. Significant improvements are observed in certain tasks, such as a 5.07% increase on 16-shot Caltech101. The average accuracy across 11 tasks surpasses the best baseline by 3.51%. LMC-T demonstrates similar performance and even exceeds baselines in lower-shot scenarios, with 1-shot and 4-shot LMC-T outperforming 2-shot and 8-shot baselines, respectively. The illustrations demonstrate that the proposed methods exhibit excellent robustness across diverse real-world domain tasks, particularly as the proposed methods, LMC and LMC-T, outperform all baselines.

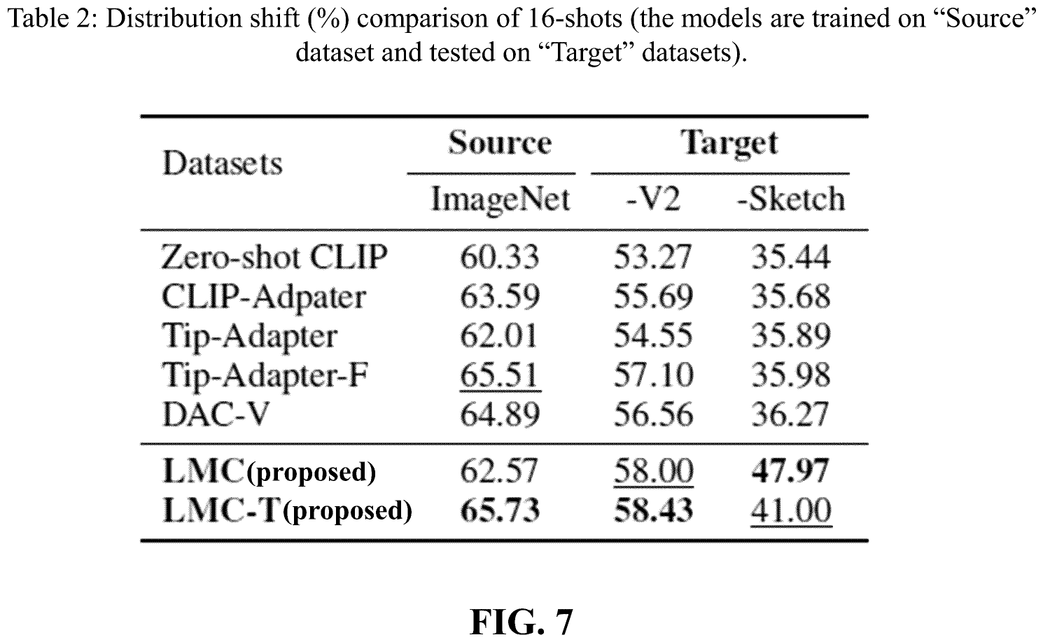

Distribution Shift: the robustness of the LMC to distribution shifts is further evaluated by training on the “Source” dataset and testing on the “Target” dataset. Specifically, training is conducted on ImageNet, followed by cross-dataset evaluation on ImageNet-V2 and ImageNet-Sketch, which share the same categories as ImageNet but feature different domain styles. As shown in Table 2 of FIG. 7, the best performance on both target domains is achieved by the proposed methods. When evaluating on the hand-drawn style ImageNet-Sketch, a notable advantage of 11.70% over the previous best DAC-V is exhibited by the LMC. It is conjectured that the descriptions from LMM can filter salient semantics and significantly restrain the negative influence of image styles that might be encoded into visual features. This demonstrates the robustness of the proposed methods in out-of-distribution (OOD) settings.

### Experiment-Performance: Ablation Studies

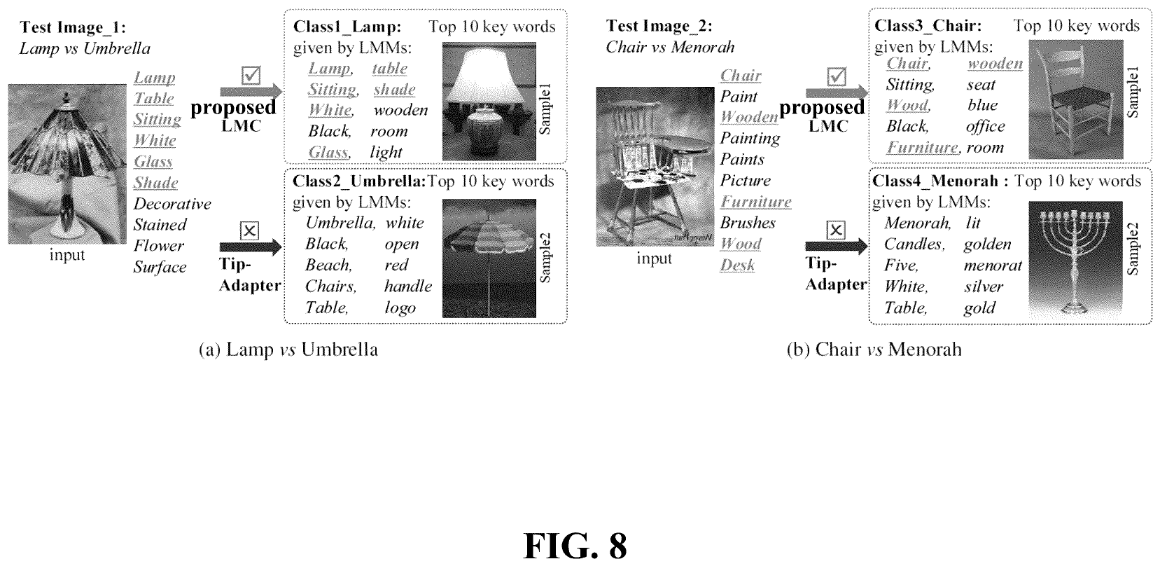

Effectiveness of Linguistic Descriptions: the benefits of LMMs are explored by addressing the question, “what can LMMs tell us?”. There are cases where the test sample is wrongly categorized by Tip-Adapter but correctly classified by the LMC, as shown in FIG. 8. FIG. 8 demonstrates examples from Caltech101, including part (a) Lamp vs Umbrella and part (b) Chair vs Menorah. Due to their analogous appearance, some test samples are wrongly categorized by Tip-Adapter but correctly predicted by the proposed method (i.e., LMC solution). Descriptions for the test image and support images of the true class share several keywords, which refer to the concept correlation. The shared keywords are more related to the salient semantics rather than the background and even include the true class label.

This often occurs when the test image accidentally shares close visual characteristics with false support classes. The top keywords of descriptions for specific test samples, all samples from positive classes, and negative classes are filtered, respectively. A critical induction is that the test image and positive class tend to share a list of keywords, referred to as “hidden correlations of concepts,” motivated by the fact that these concepts often appear in the same scene with high probability. Furthermore, the keywords are more related to the salient target object rather than the background, and even the true class label is included (e.g., “Lamp” and “Crab”). Thus, it is argued that LMMs can perform coarse-grained classification in advance and reduce ambiguity by focusing on salient semantics.

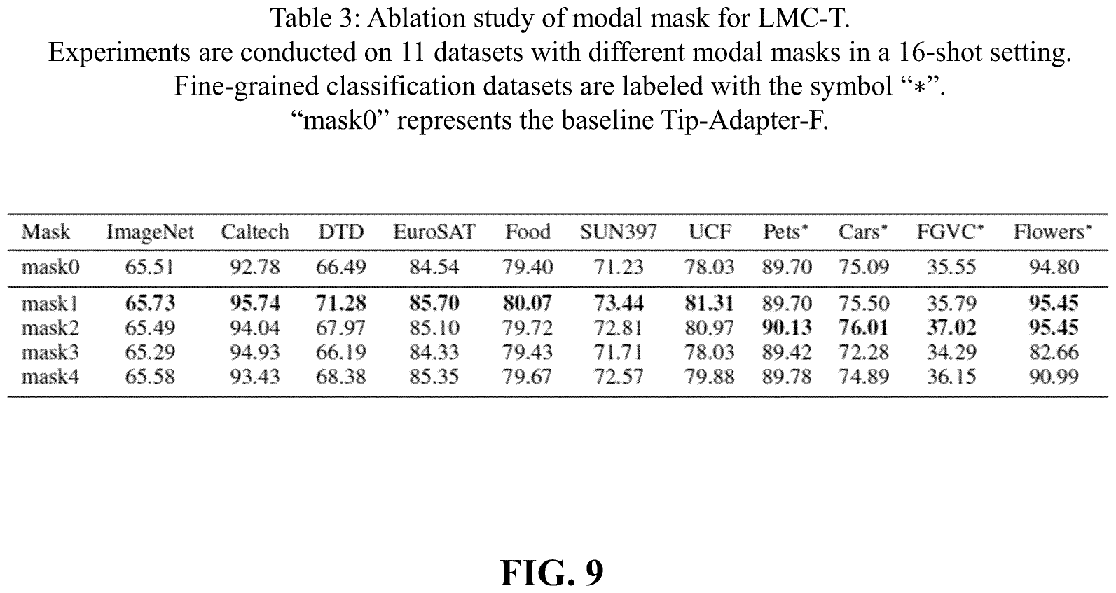

Multi-modal and Cross-modal Contrast: in Table 3 of FIG. 9, the effectiveness of the proposed modal mask for multi-modal and cross-modal contrast is explored. Tip-Adapter is actually a special form of the LMC when mask₀ is set to {Mask_{f}, Mask_{z}}={ψ(1, 0), ψ(0, 0)}. Meanwhile, Mask1={ψ(1, 0), ψ(0, 1)}, Mask2={ψ(1, 0), ψ(1, 0)}, and Mask3={ψ(0, 1), ψ(0, 1)} extend the distance metric from single-modal space to multi-modal and cross-modal space. Specifically, Mask1 compares both visual and textual features between the test image and the support set in a multi-modal way, while mask₂ contrasts support visual features with both test visual and textual features, which is a cross-modal approach. As shown in Table 3 of FIG. 9, mask settings from mask₁ to Mask3 outperform the baseline on most datasets, especially mask₁ and Mask₂. Mask₂ performs best for fine-grained datasets marked with the symbol “*” and Mask1 for normal coarse-grained datasets. Empirically, it is argued that cross-modal and multi-modal contrast is more effective for these two categories of datasets, respectively.

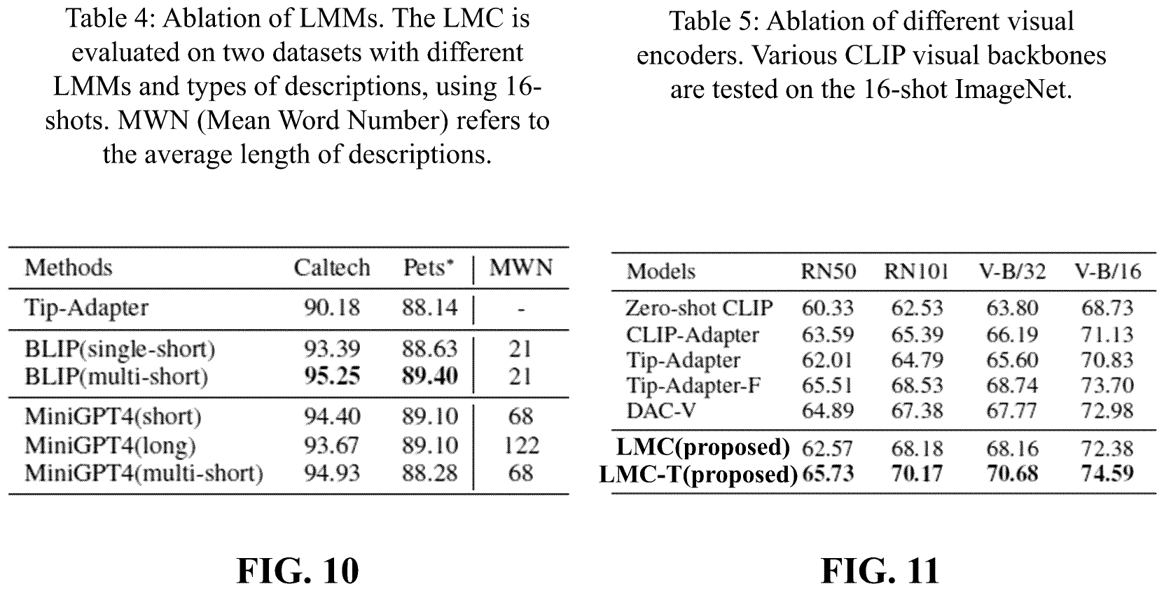

Different LMMs: the influence of different LMM models (e.g., BLIP and MiniGPT4) and types of text descriptions is ablated. BLIP generates relatively short descriptions, so the effectiveness of integrating multiple text features is examined. Additionally, prompts are used to ask MiniGPT4 for “short” and “long” descriptions, and the effect of sentence length is evaluated. Experiments are conducted on Caltech101 and Oxford-Pets. As shown in Table 4 of FIG. 10, multiple short captions from BLIP perform the best. It is explained that MiniGPT4 inherits limitations of LLMs, such as hallucinating nonexistent knowledge, which blurs the textual features. One related work proves that longer captions tend to have higher hallucination rates, verifying the observation from Table 4 of FIG. 10 that MiniGPT4 returns much longer captions than BLIP.

Different Visual Encoders: the LMC and LMC-T are evaluated with different visual encoders on the 16-shot ImageNet. As shown in Table 5 of FIG. 11, LMC-T consistently outperforms other methods, demonstrating its generalization ability across backbone architectures.

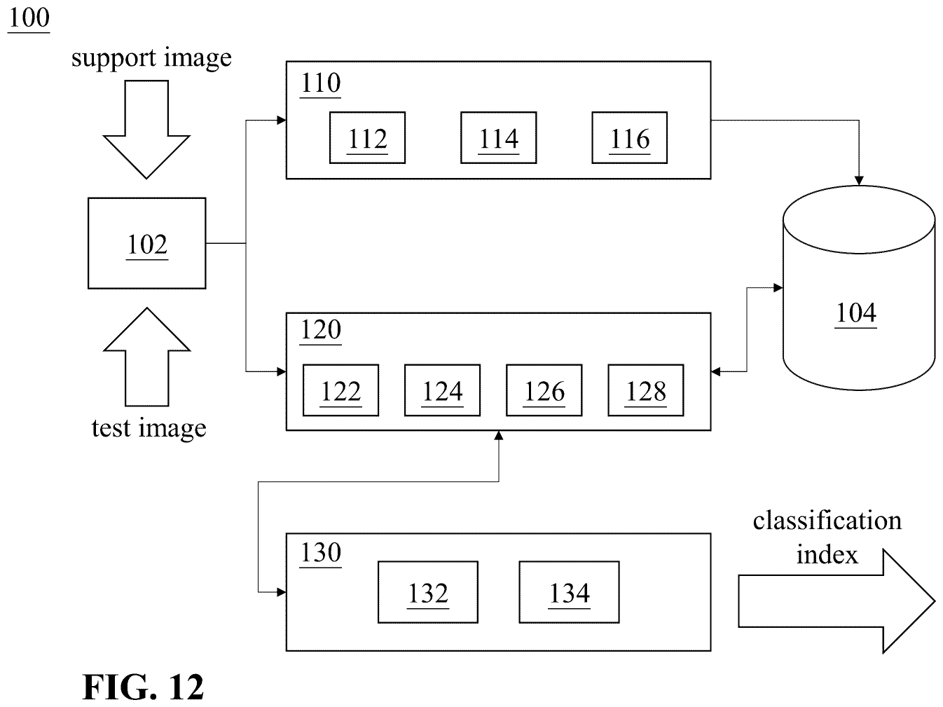

FIG. 12 depicts an overview of the block configuration of a large multi-modal models-boosted (LMMs-boosted) multi-modal contrast (LMC) framework system 100 according to one embodiment of the present invention. A LMMs-boosted LMC framework system 100 can executes the LMC solution as afore-described and includes a user interface 102, a multi-modal feature generation module 110, a multi-modal feature contrast module 120, and a prediction logic module 130.

The user interface 102 is configured to receive input images and operates in two distinct modes, including a support image mode and a test image mode. In the support image mode, the user interface 102 receives support images and processes them for subsequent transmission to the multi-modal feature generation module 110. In the test image mode, the user interface 102 receives test images and directs the data to the multi-modal feature contrast module 120. The user interface 102, with its dual-mode functionality, facilitates smooth and accurate data delivery to the appropriate modules, optimizing the processing of both support and test images within the system.

The multi-modal feature generation module 110 is responsible for transforming the support set images into text features, where the support set images are utilized for system training. The multi-modal feature generation module 110 includes a large multi-modal module 112, a text encoder module 114, and a visual encoder module 116.

The large multi-modal module 112 processes the support set images to generate textual descriptions, with each image receiving multiple descriptions to reduce variability. The text encoder module 114 takes these textual descriptions as input and computes the corresponding text embedding features. The visual encoder module 116 handles the support set images to generate visual embedding features by converting raw image data of the support set images into high-dimensional numeric vectors that encapsulate both semantic and structural information. By combining the text embedding features and visual embedding features, the multi-modal feature generation module 110 constructs a multi-modal support feature pool 104, which is pivotal for subsequent contrast operations. The multi-modal feature generation module 110 bridges the gap between visual data and textual data, so as to transform support set images into textual descriptions and their corresponding embeddings, while also to integrate visual embeddings to support an inference stage.

The multi-modal feature contrast module 120 operates during the inference stage, comparing test image features with the multi-modal support feature pool 104 to facilitate prediction. The multi-modal feature contrast module 120 includes a test feature extraction module 122, a support feature pool module 124, a mask function module 126, and an exponential function module 128.

The test feature extraction module 122 includes a visual encoder model and a text encoder model and is configured to process test images to extract visual and textual features. Visual features are extracted using the visual encoder model, while textual features are derived through the text encoder model from the textual descriptions of the test images. The support feature pool module 124 maintains the multi-modal support feature pool 104 constructed by the multi-modal feature generation module 110, facilitating comparisons with test image features during the inference stage. The mask function module 126 determines which features of visual, textual, or both should be used for comparison between the test images and support images based on predefined mask functions. The mask function module 126 provides flexibility in feature selection. The exponential function module 128 calculates similarity between test image features and support image features using affinity metrics, applying adjustable parameters to control the sharpness of predictions and enhance the accuracy of the final results. Overall, the multi-modal feature contrast module 120 calculates similarities between test image features and support set features across visual and textual modalities, supporting predictions through the generation of prediction logic for both modalities as a basis for final inference.

The prediction logic module 130 integrates predictions from multiple sources to produce a more precise outcome. The prediction logic module 130 includes a zero-shot prediction module 132 and a logic fusion module 134. The zero-shot prediction module 132 generates an initial prediction using the visual features of test images, leveraging a pre-trained classifier thereof to produce preliminary classification results. The logic fusion module 134 combines these results with the predictions derived from the multi-modal feature contrast module 120, enabling refined predictions through logical integration. After fusion, the prediction logic module 130 delivers a final result with enhanced accuracy by selecting the index of maximum classification confidence. For instance, under the input image of cat, the LMMs-boosted LMC framework system 100 might output a result of “1”, which is the index of the maximum value of the output from logic fusion module 134 and “1” represents the index of ordered class name “cat” from all categories.

In one embodiment, the LMMs-boosted LMC framework system 100 is configured to execute a training stage using a support image set. During the training stage, the LMMs-boosted LMC framework system 100 receives a support image set as input. These support images are transmitted by the user interface 102 in support image mode to the multi-modal feature generation module 110 for processing. First, the large multi-modal module 112 transforms the support images into multiple textual descriptions to reduce semantic variability. These descriptions are then passed to the text encoder module 114, which computes the corresponding text embedding features. Simultaneously, the visual encoder module 116 processes the support images to extract visual embedding features, converting raw image data into high-dimensional vectors capturing both semantic and structural information.

The multi-modal feature generation module 110 combines the text and visual embedding features to construct a multi-modal support feature pool 104, which is maintained by the support feature pool module 124 for subsequent contrast operations during the inference stage. This training process enables the comprehensive extraction and preparation of multi-modal features from the support images, making them ready for classification tasks.

In one embodiment, the LMMs-boosted LMC framework system 100 is configured to execute an inference stage with respect to one or more test images for classification. During the inference stage, the LMMs-boosted LMC framework system 100 receives test images as input. The user interface 102, operating in test image mode, transmits the test image data to the multi-modal feature contrast module 120. The test feature extraction module 122 processes the test images using an internal visual encoder model to extract visual features and an internal text encoder model to derive text features from the textual descriptions of the test images. These test image features are then compared with the multi-modal support feature pool 104 maintained by the support feature pool module 124.

In the contrast process, the mask function module 126 determines whether to use visual features, textual features, or both for comparison based on predefined mask functions. Similarity calculations are performed by the exponential function module 128 using affinity metrics, with adjustable parameters to control the sharpness and accuracy of predictions. The results of the comparison are transmitted to the prediction logic module 130, where the zero-shot prediction module 132 generates an initial prediction based on the visual features of the test images. The logic fusion module 134 then integrates the initial prediction with the results from the multi-modal feature contrast module to produce a refined prediction.

In various embodiments, the scenarios of the LMMs-boosted LMC framework system 100 may span several industries. In e-commerce, it helps categorize products with limited samples, such as quickly classifying a new product photo as either “men's clothing” or “women's clothing.” In the medical imaging field, the system can classify disease types, such as distinguishing between “tumor” and “normal” conditions, using a small set of labeled X-rays or MRI images. In the security domain, when a surveillance system has only a few images of suspicious individuals, the system utilizes text descriptions and multi-modal support pools for feature comparison, aiding in the classification of potential threats. In education and search engines, the system can be applied to wildlife conservation tasks. The system can help classify rare animal species from photos in remote areas with only a few labeled images, which are collected to capture patterns of each species like fur textures, feather colors, or body shapes.

As discussed above, LMC, an LMM-boosted framework for adapting CLIP to downstream few-shot classification tasks, is proposed. The introduced LMM maps samples into linguistic descriptions and emphasizes unused discriminative features in the textual embedding space by filtering salient semantics, conducting coarse-grained pre-classification, and leveraging hidden correlations of concepts with pre-learned knowledge. By integrating domain-specific prior knowledge from both textual and visual spaces into a multi-modal support feature pool, an optimal distance metric is explored by extending from single-modality to multi-modal and cross-modal regimes with two modal masks. Extensive experiments on 11 few-shot benchmarks and 2 OOD datasets demonstrate that the method possesses state-of-the-art robustness on diverse real-world domain tasks and distribution shifts.

By implementing the current configuration, the computational speed can be significantly enhanced, optimizing the efficiency of feature extraction and classification tasks in multi-modal systems. This framework improves the accuracy and fluency of inference processes, allowing for more effective integration of both visual and textual data during classification. These improvements not only streamline the data processing pipeline but also enhance overall system performance, making the user experience more responsive and efficient in real-world applications.

The functional units and modules of the apparatuses and methods in accordance with the embodiments disclosed herein may be implemented using computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

All or portions of the methods in accordance to the embodiments may be executed in one or more computing devices including server computers, personal computers, laptop computers, mobile computing devices such as smartphones and tablet computers.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A large multi-modal models-boosted (LMMs-boosted) multi-modal contrast (LMC) framework system, comprising:
a user interface configured to receive input images and operating in two distinct modes, including a support image mode and a test image mode;
a multi-modal feature generation module, wherein the user interface in the support image mode receives support set images and send them to the multi-modal feature generation module, where the support set images are utilized for system training, and wherein the multi-modal feature generation module is configured to transform the support set images into text features and visual features and deliver them into a multi-modal support feature pool to support an inference stage;
a multi-modal feature contrast module, wherein the user interface in the test image mode receives at least one test image and sends them to the multi-modal feature contrast module, and wherein the multi-modal feature contrast module is configured to compare test image features of the test image with the support set features within the multi-modal support feature pool and to calculate similarities between the test image features and the support set features across visual and textual modalities; and
a prediction logic module configured to integrate predictions from multiple sources generated by the multi-modal feature contrast module to produce a classification index for the test image with the most likely classification and its associated confidence score.

2. The LMMs-boosted LMC framework system of claim 1, wherein the multi-modal feature generation module further comprises a large multi-modal module configured to processes the support set images to generate textual descriptions, with each image receiving multiple descriptions to reduce variability.

3. The LMMs-boosted LMC framework system of claim 2, wherein the multi-modal feature generation module further comprises:
a text encoder module configured to take the textual descriptions as input and compute text embedding features correspondingly; and
a visual encoder module configured to handle the support set images to generate visual embedding features by converting raw image data of the support set images into high-dimensional numeric vectors that encapsulate both semantic and structural information.

4. The LMMs-boosted LMC framework system of claim 3, wherein the multi-modal feature generation module is further configured to combine the text embedding features and the visual embedding features so as to construct the multi-modal support feature pool.

5. The LMMs-boosted LMC framework system of claim 1, wherein the multi-modal feature contrast module further comprises a test feature extraction module with a visual encoder model and a text encoder model, and wherein the test feature extraction module is configured to process the test image to extract visual and textual features thereof using the visual encoder model and the text encoder model.

6. The LMMs-boosted LMC framework system of claim 5, wherein the multi-modal feature contrast module further comprises a support feature pool module configured to maintain the multi-modal support feature pool constructed by the multi-modal feature generation module.

7. The LMMs-boosted LMC framework system of claim 6, wherein the multi-modal feature contrast module further comprises:
a mask function module configured to determine which features of visual, textual, or both are used for comparison between the test image and the support set images based on predefined mask functions thereof; and
an exponential function module configured to calculate similarity between the test image features and the support image features using affinity metrics.

8. The LMMs-boosted LMC framework system of claim 1, wherein the prediction logic module further comprises a zero-shot prediction module and a logic fusion module, and wherein the zero-shot prediction module generates an initial prediction using the visual features of the test image, leveraging a pre-trained classifier thereof to produce a preliminary classification result, and the logic fusion module is configured to combine the s preliminary classification result with the predictions derived from the multi-modal feature contrast module, enabling refined predictions through logical integration, such that the prediction logic module outputs the classification index.

9. A method for using the LMMs-boosted LMC framework system according to claim 1 to execute a training stage using a support image set, comprising:
receiving, by the LMMs-boosted LMC framework system, a support image set as input during a training stage;
transmitting, by the user interface in the support image mode, support images of the support image set to the multi-modal feature generation module for processing;
transforming, by a large multi-modal module of the multi-modal feature generation module, the support images into multiple textual descriptions to reduce semantic variability;
passing the textual descriptions to a text encoder module of the multi-modal feature generation module, which computes the corresponding text embedding features;
processing, by a visual encoder module of the multi-modal feature generation module, the support images to extract visual embedding features, thereby converting raw image data into high-dimensional vectors capturing both semantic and structural information; and
combining, by the multi-modal feature generation module, the text and visual embedding features to construct the multi-modal support feature pool for subsequent contrast operations during the inference stage.

10. A method for using the LMMs-boosted LMC framework system according to claim 1 to execute an inference stage with respect to at least one test image for classification, comprising:
receiving, by the LMMs-boosted LMC framework system, at least one test image as input during the inference stage;
transmitting, by the user interface in the test image mode, the test image to the multi-modal feature contrast module;
processing, by a test feature extraction module of the multi-modal feature contrast module, the test image using an internal visual encoder model to extract visual features and an internal text encoder model to derive text features from the textual descriptions of the test image, obtaining test image features;
comparing the test image features with the multi-modal support feature pool;
performing a contrast process by a mask function module of the multi-modal feature contrast module to determine whether to use visual features, textual features, or both for comparison based on predefined mask functions;
performing similarity calculations by an exponential function module of the multi-modal feature contrast module using affinity metrics, with adjustable parameters to control sharpness of predictions;
transmitting a result of comparison executed by the exponential function module to the prediction logic module;
generating, by a zero-shot prediction module of the prediction logic module, an initial prediction based on the visual features of the test image; and
integrating, by a logic fusion module of the prediction logic module, the initial prediction with the result from the multi-modal feature contrast module to produce a refined prediction, serving as the classification index.
